(19) United States
(12) Patent Application Publication
(10) Pub. No.: US 2014/0115486 A1
(43) Pub. Date: Apr. 24, 2014

(54) MANUAL CLICKER APPLICATION

(71) Applicant: INNOVATION SOFTWARE, LLC, Cedar Falls, IA (US)

(72) Inventors: Chad Benson, Cedar Falls, IA (US); Mike Frost, Cedar Falls, IA (US)

(73) Assignee: INNOVATION SOFTWARE, LLC, Cedar Falls, IA (US)

(21) Appl. No.: 13/656,225

(22) Filed: Oct. 19, 2012

(51) Int. Cl. G06F 3/048

(52) U.S. Cl. 715/739

(57) ABSTRACT

A method for manual intervention in a dialing process includes maintaining a list of records containing phone numbers in a database stored on a computer readable storage medium, receiving at a computer and from the user a click for each of the records within the list of records in the database stored on the computer readable storage medium, and storing on a computer readable storage medium a record of the click, an identity of the user performing the click, and an association between the click and one of the records within the list of records. For each click, the method provides for electronically communicating the corresponding phone number of one of the records within the list to a telecommunications system for dialing the phone number. The method may further include dialing the phone number using the telecommunications system.

### FIELD OF THE INVENTION

The present invention relates to alternatives to using automatic or predictive dialers. More specifically, the present invention relates to a manual intervention process to allow users to manually perform clicking operations for records including phone numbers before the phone numbers are communicated to a communication system.

### BACKGROUND OF THE INVENTION

Automatic and predictive dialers are widely used to increase efficiency of call center operations where outgoing phone calls are made on a large scale. Automatic dialers randomly or sequentially dial various numbers and detect when a live person answers the phone and then transfers the call to a human operator. Predictive dialers, while not necessarily random or sequential dialers, use various algorithms to reduce the amount of time that human operators spend waiting between calls transferred to them while also minimizing the occurrences of a live person answering the phone when no human operator is available.

In general, a call-system qualifies as “predictive” if that system dials, without human intervention, collections of phone numbers where the collection size varies continuously over time based on that system's internal decisions. The goal of a predictive dialer is to match an agent with one or more connects upon availability. That is to say, to predict how many consumers will answer the phone if N phone lines are dialed at time T (as a function of N and T) and then to select N and T so that when an agent becomes available he/she will have at least one available consumer to talk to after finishing his/her previous call. This is accomplished by tracking hits (someone answers the phone call) as a percentage of a certain number of previous attempts. By watching the hit rate through time, a predictive dialer is able to maintain a ratio of lines dialing per qualifying agent in order to successfully match up connected calls with available agents. It is impossible for a dialer to be predictive as it is understood in the industry without at least having BOTH of the following two features:
1. The ability to track hit rate through time and provide a prediction for what the hit rate of a current dial-out will be.
2. A dynamically updated matrix, algorithm or some other dynamic methodology for determining how many lines to dial at a given, specific point in time based on a number of agents, agent statuses and hit rate (other tracked statistics may be included in the calculation of the matrix but are not necessary for a dialing algorithm to be considered predictive).

Federal laws limit the use of automatic and predictive dialers in certain situations and place various requirements on their use. For example, the Telephone Consumer Protection Act (TCPA) regulations state that unauthorized cell phones may not be dialed via an Automated Telephone Dialing System (ATDS). What is needed is a way to allow for a manual intervention to be performed by human operators in an efficient manner which still allows some of the benefits of technology to be used.

### SUMMARY

Therefore, it is a primary object, feature, or advantage of the present invention to improve over the state of the art.

It is a further object, feature, or advantage of the present invention to provide for a dialing method and system which requires a manual intervention on the part of the human operator for each number which is dialed by a computerized system.

It is a still further object, feature, or advantage of the present invention to fully comply with applicable Telephone Consumer Protection Act (TCPA) regulations.

It is another object, feature, or advantage of the present invention to document when each phone number to be dialed is manually selected by a human operator.

Yet another object, feature, or advantage of the present invention to provide a way for call centers who use computerized systems to comply with applicable regulations with a minimal disruption in their processes and systems.

A still further object, feature, or advantage of the present invention is to allow for a maximum number of clicks at a time to be set without the use of a predictive algorithm.

Another object, feature, or advantage of the present invention is to allow a computerized system to use different technologies based on whether the phone number is associated with unauthorized cell phone or a landline.

One or more of these and/or other objects, features, or advantages will become apparent from the specification and claims that follow. Note that no single embodiment need exhibit each and every object, feature, or advantage described herein as different embodiments may exhibit different objects, features, and advantages.

According to one aspect of the present invention, a method for manual intervention in a dialing process is provided. The method includes maintaining a list of records containing phone numbers in a database stored on a computer readable storage medium, receiving at a computer and from the user a click for each of the records within the list of records in the database stored on the computer readable storage medium, and storing on a computer readable storage medium a record of the click, an identity of the user performing the click, and an association between the click and one of the records within the list of records. For each click, the method provides for electronically communicating the corresponding phone number of one of the records within the list to a telecommunications system for dialing the phone number.

According to another aspect of the present invention, a method for providing a cloud-based service to provide for manual intervention in a dialing process is provided. The method includes maintaining a list of records containing unauthorized phone numbers in a database stored on a computer readable storage medium. The method further includes providing access to a manual clicker application through a server configured to access the database. The method further includes providing a user interface to a user of the manual clicker application, the user interface configured to receive clicks from a user. The method further includes receiving clicks from the user targeted at an icon of the user interface and storing within the database a record of each click from a user and associating each click from the user with one of the records and a corresponding unauthorized phone number. The method further includes electronically communicating each of the corresponding unauthorized phone numbers after storing the record of each click.

### BRIEF DESCRIPTION OF THE FIGURES

FIG. 1 illustrates one example of a system.

FIG. 2 illustrates a work flow of a user clicking

FIG. 3 illustrates another method.

FIG. 4 illustrates one example of a configuration or database schema for a relational database which may be stored on a computer readable storage medium.

FIG. 5 illustrates a login screen for a clicker application.

FIG. 6 illustrates a screen display for a clicker application which allows a user to click once for each of the records within a list of records.

FIG. 7 illustrates another screen display for a clicker application where there are no phone numbers left in the list.

FIG. 8 illustrates a screen display showing a new user creation panel.

FIG. 9 illustrates a screen display showing a modify existing user panel.

FIG. 10 illustrates a screen display showing a rest password panel.

### DETAILED DESCRIPTION

The present invention relates to a manual dial software application that may be used to provide a manual intervention in the dialing process. The manual dial software application may be a cloud-based software-as-a-service (SaaS) application. The manual dial application allows for a human being to enter unauthorized cell phone numbers into a list by clicking on an icon, the phone number or other user interface elements associated with a phone number. Once selected by the user through the clicking process, each of the cell phone numbers may then be dialed. The manual clicker application is preferably dialer agnostic. Thus, the present invention may be used with any number of commercial telecommunications systems. Such systems may provide for additional functions such as recording calls and maintaining compliance with laws, regulations, and/or internal policies. The user may log in to the web site and then click an icon multiple times until the list of accounts has been completed or until a predetermined maximum number of allowed clicks has been reached. The application may then log the click as well as information on the clicking user as a history comment in the client's collection software and will also send the clicked phone number to a list to be dialed. Additionally, there may be an option for a system administrator to change passwords, track clicks, or otherwise administer the application and its use.

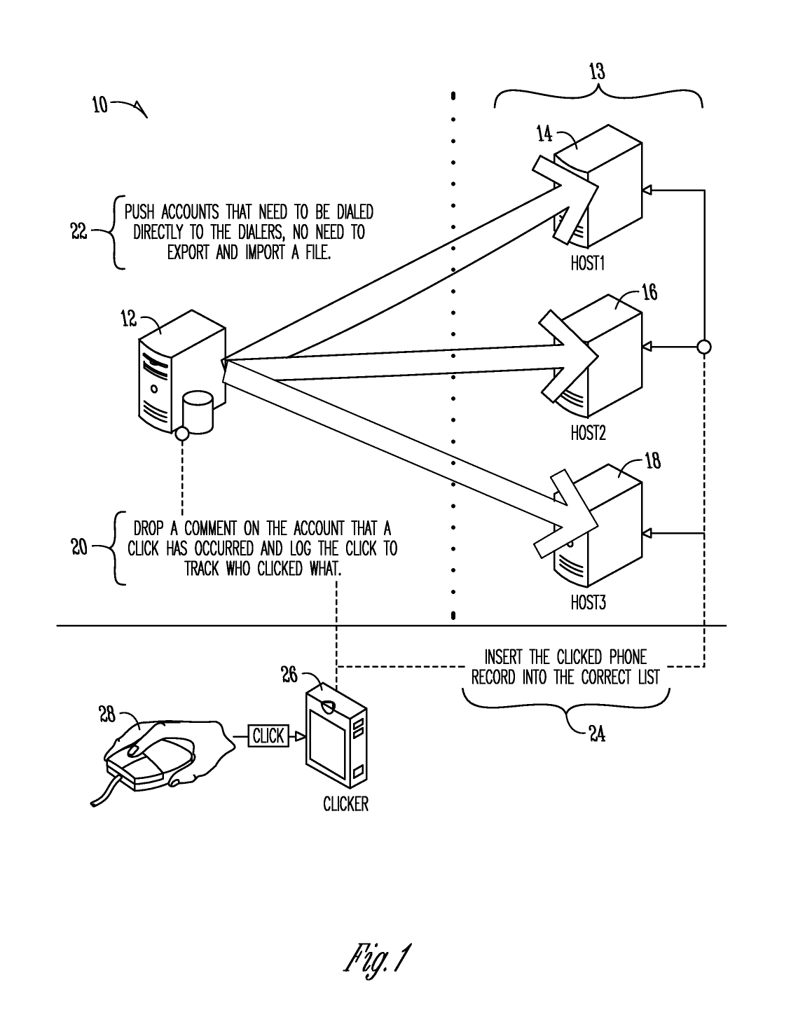

FIG. 1 illustrates one example of a system 10. The system 10 includes a server 12. The server 12 is in operative communication with a telecommunication system 13 which may include one or more hosts such as a first host 14, a second host 16, and a third host 18. The server 12 and hosts 14, 16, 18 may communicate over a network.

A mouse 28 or other computer hardware device may be used to select a phone number for the list. For purposes, here, the selection may be in the form of a mouse click which is then communicated to a clicker 26. In response to the selection, in step 24 the clicked phone record may be inserted into the correct list. In addition in step 20 a comment may be entered on the account to indicate that a click has occurred and the click may be logged to indicate which phone record was clicked and which individual performed the clicking. In step 22 accounts that need to be dialed may be dialed without needing to import and/or export a file to do so. Thus, direct dialing is performed where a click is used to initiate a call. Thus, calls made are not a result of any type of random or sequential process but instead may be dialed on direct lines in response to this form of manual intervention.

In addition, it is to be understood that the system 10 may be configured to determine if phone numbers are unauthorized cell phone numbers or not. If phone numbers are unauthorized cell phone numbers, the system 10 may place the unauthorized cell phone numbers in the list of records associated with the clicker 26 and for phone numbers which are not unauthorized cell phone numbers, these phone numbers may be dialed by the telecommunication system 13 in the conventional manner without manual intervention.

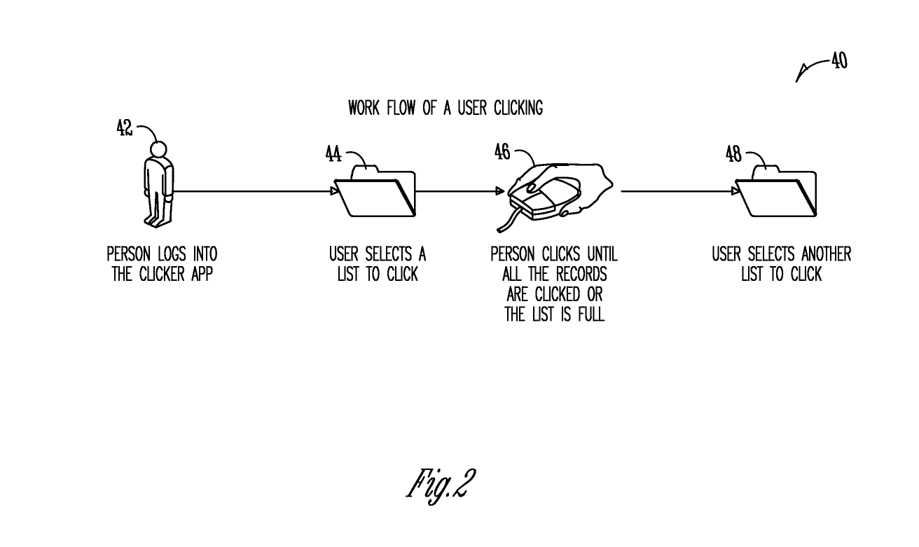

FIG. 2 illustrates a work flow of a user clicking according to a method 40. In step 42 a person logs into the clicker application. In step 44, the user selects a list to click. In step 46, the user clicks display records until all of the records are clicked or the list is full. In step 48 a user may select another list to click.

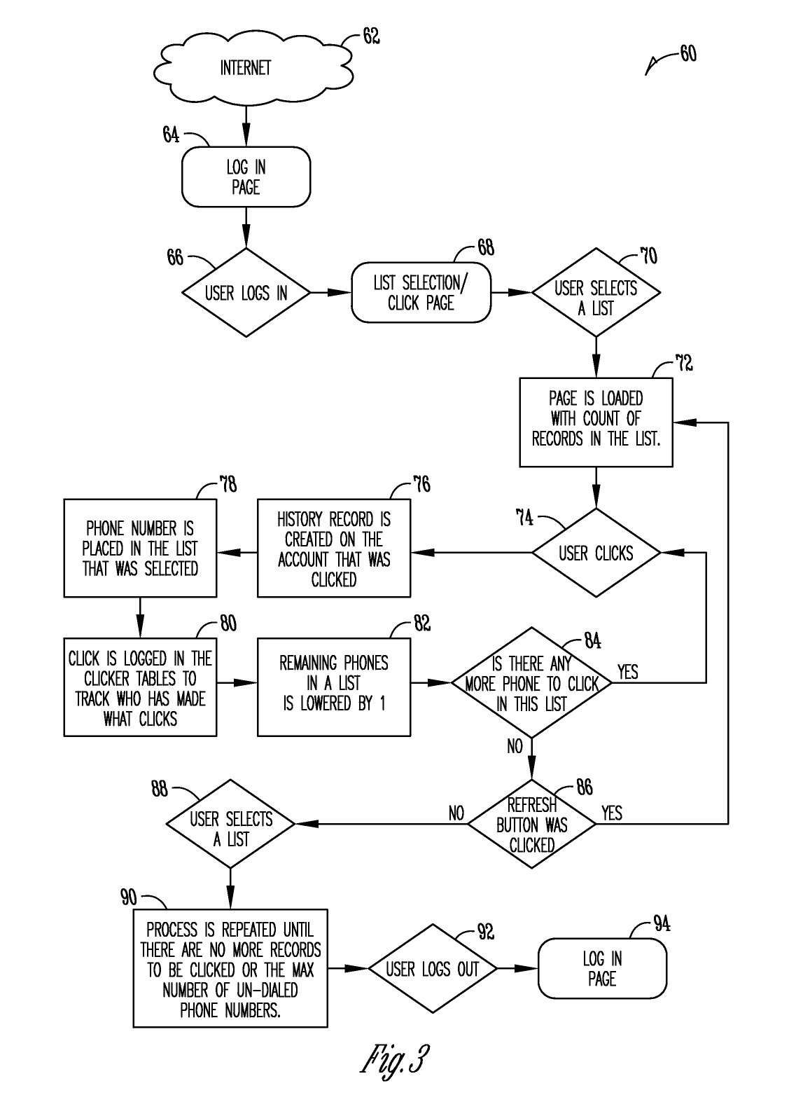

FIG. 3 illustrates another method 60. The method 60 may be performed using a cloud-based service associated with the internet 62. In step 64 a log-in page may be displayed by a user. In step 66 a user may then log into the service. In step 68 a list selection/click page may be presented to the user. In step 70 the user may select a list from available lists. In step 72 a page is loaded which may include a count of the records contained in the list. In step 74 a user clicks or otherwise makes a selection of one of the records from the list. In step 76, a history record may be created on the account that was clicked. In step 78 a phone number may be placed in the list that was selected. In step 80 the click may be logged in the clicker tables to track who has made what clicks. In step 80 the count of remaining phone records in the list is decreased by one.

In step 84 a determination is made as to whether there are any more phone records to click in the list. If there are then the process returns to step 74 to await the next user click. If there are not then in step 86 a determination is made as to whether or not the refresh button was selected. If it was, then in step 72 the page is loaded again with a new count of records in the list. If not, then in step 88 a user selects a list. In step 90 the process is repeated until there are no more records to be clicked or the maximum number of un-dialed phone numbers is reached. In step 92 the user may log out and in step 94 a log in page may be displayed again.

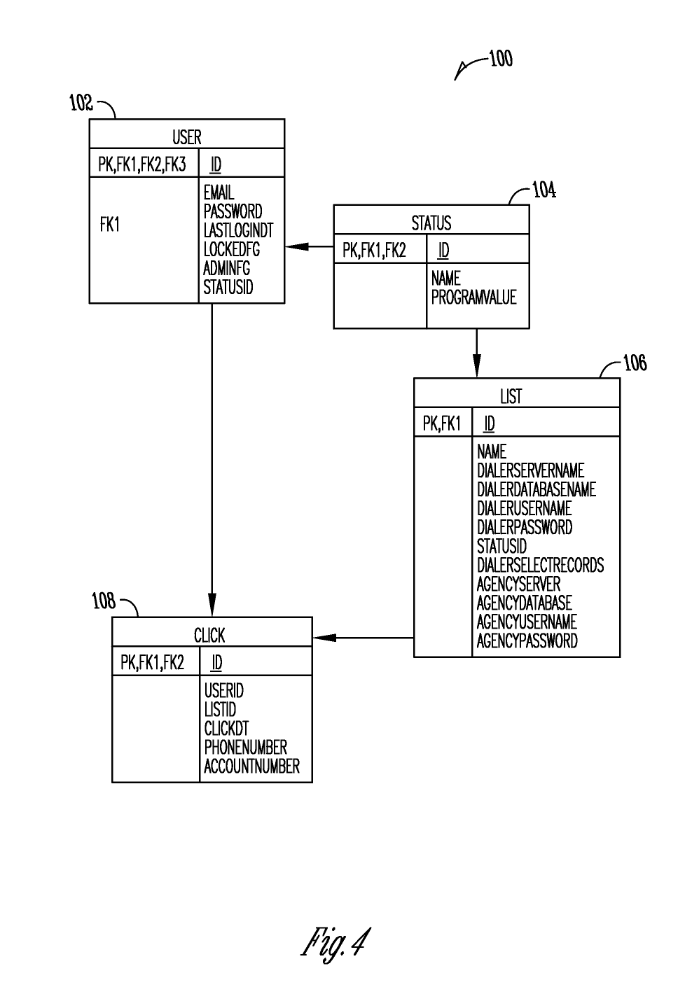

FIG. 4 illustrates one example of a configuration or database schema for a relational database 100 which may be stored on a computer readable storage medium. A first table 102, a second table 104, a third table 106, and a fourth table 108 are provided. The first table 102 is a user table. The second table 104 is a status table. The third table 106 is a list table, and the fourth table 108 is a click table. Each table may have various fields. Fields associated with the user table 102 may include an email address of the user, a password of the user, a date/time of their last login, a locked field to indicate whether that user is locked, and administrator field to indicate whether the user is an administrator, and a status identifier. Thus, information about each user and there login may be stored. Fields associated with the status table 104 may include a name and a program value. Fields associated with the list table 106 may include a name, a server name, a database name, a username, a password, a status identifier, a select records field, an agency server field, an agency database field, an agency username, and an agency password. Thus, information regarding each list and attendant information may be maintained. Fields associated with the click table 108 may include a user identifier field, a list identifier field, a time and date of a click, a phone number associated with the click, and an account number associated with the click. Thus information regarding each click of a phone number may be maintained. In addition, each table may have a primary key (PK) and one or more foreign keys (FK1, FK2, FK3).

Although a particular database schema is shown in FIG. 4 it is to be understood that the present invention contemplates any number of variations, alternatives, and changes including additional tables, fewer tables, additional fields, fewer fields, and different keys.

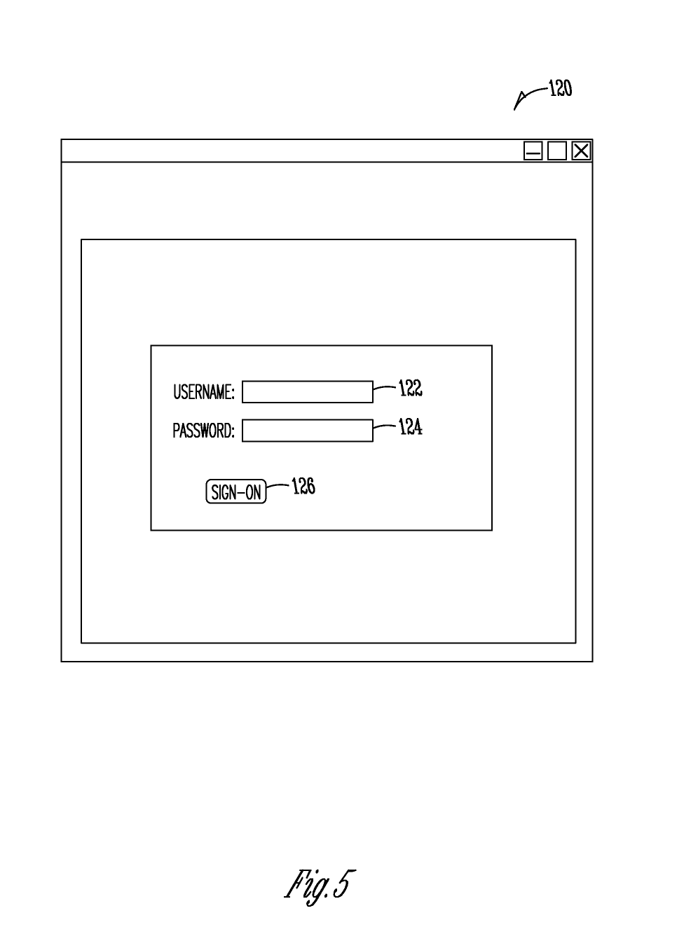

FIG. 5 illustrates a login screen 120. The login screen 120 may include a username input 122 which may accept an email address as a username and a password input 124 as well as a sign-on button 126. The username and password input may match a record in the user table. The date and time of a successful login may be stored as a part of the user table 102 of FIG. 4.

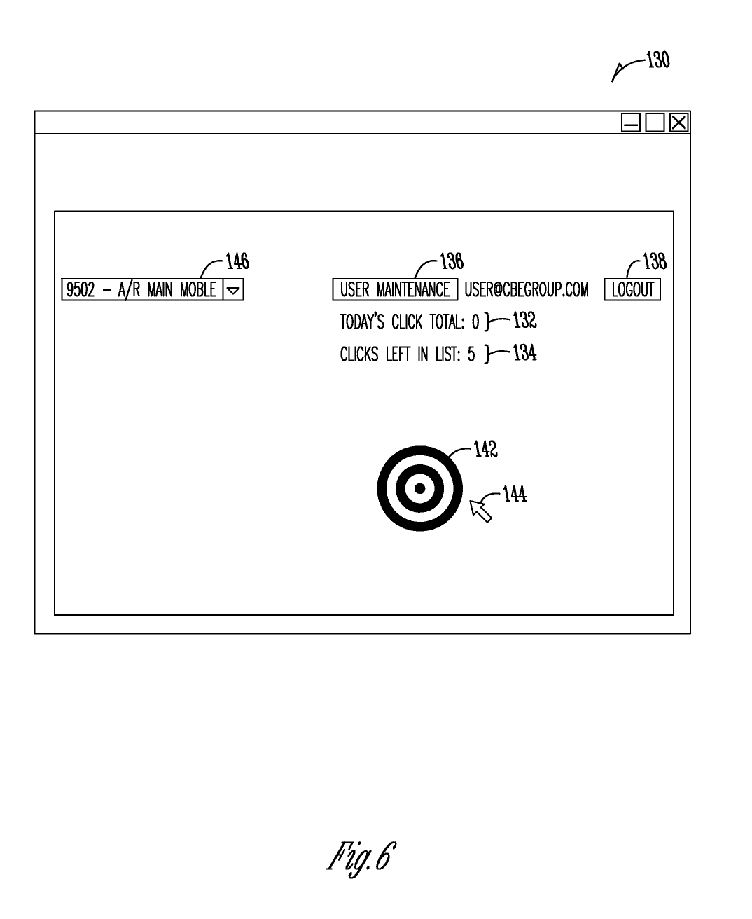

FIG. 6 illustrates a screen display 130 showing a main page. Various user interface elements may include buttons or tabs such as for user maintenance 136 and to logout 138. A current day click total 132 is shown as well as the number of clicks left in the list 134. Note that there are still clicks left in the list. A list selection drop down 146 is shown which allows a user to select a list. Preferably the list is a list of unauthorized cell phone numbers. For each such record in the list, the user must provide a click or other manual intervention before the record may be communicated to a telecommunications system. The user may click on the icon 142 which may be in the form of a target. The user may do so by positioning the pointer 144 over the icon 142 and pressing a mouse button or other button associated with a user input device. The present invention contemplates that instead of a mouse, numerous types of other user input devices may be used such as a trackball, a rollerball, a joystick, a touch window, a touch screen, a touch pad, a digitizing tablet, mousekeys, keyboard, or other type of input device.

Note that in the preferred embodiment, information associated with each record is not shown. The software application performs the function of associating each of the clicks with a corresponding record in the list, thus displaying such information is not needed. However, it is contemplated that such information could be displayed. In operation, a user may continue to click while waiting to be connected for a phone call or during a phone call. It is also to be understood that the user that performs the clicking need not be the telephone operator but may be a different individual potentially at a different location.

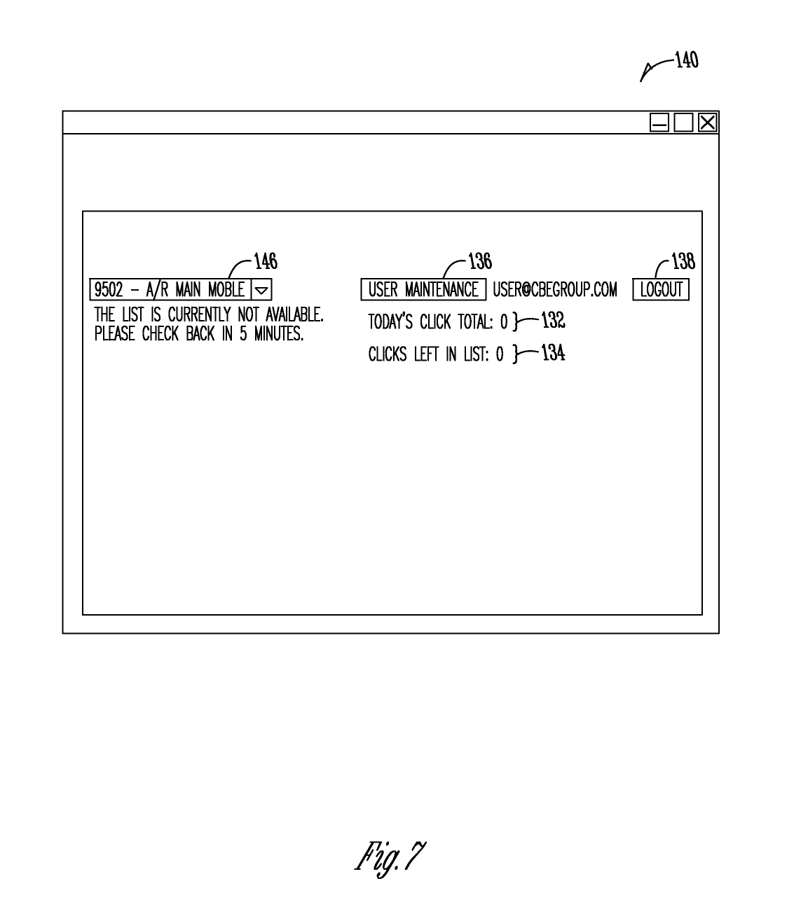

FIG. 7 illustrates a screen display 140 showing a main page where the list selected using the list selection drop down 146 is not available as there are no clicks left in the list. Thus the current day click total 132 is at zero and the number of clicks left in the list 134 is also at zero.

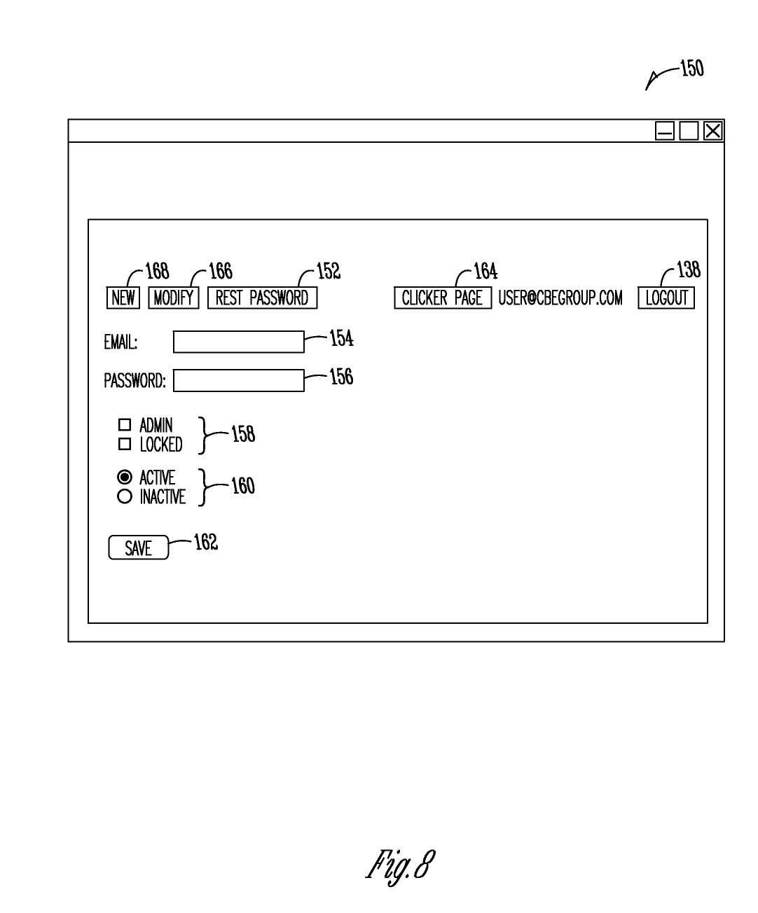

FIG. 8 illustrates a screen display 150 which includes functions associated with a user account such as a part of a user maintenance page used to create a new user account. This includes a new user tab or button 168, a modify user tab or button 166, and a reset password tab or button 152, an email field 154, a password field 156, and account attributes 158 such as to specify if the account is an administrator account or if the account is locked. Status 160 indicates whether the account is active or inactive. A save button 162 may be used to save changes associated with the information. From this page or display a user may select the clicker page 165 tab or button or may select the logout tab or button 138.

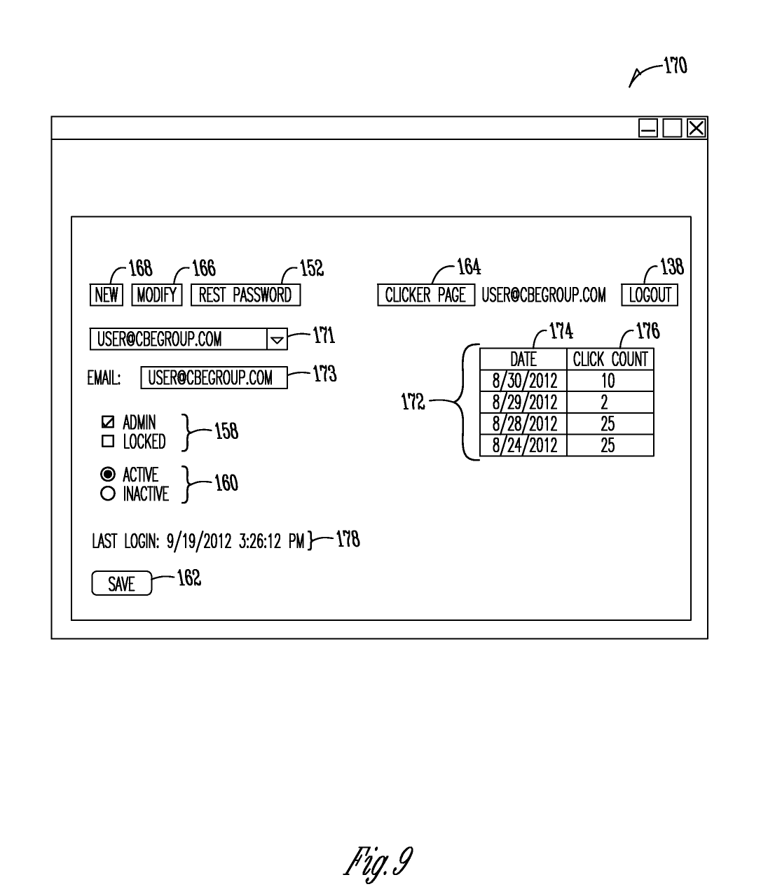

FIG. 9 illustrates a screen display 170 which shows user information associated with a modify existing user page. The user information may include a user 171 and an associated email address 173, the fact that the account is an administrator account 150 and is active 160. In addition, click information 172 is shown in a table with a column for date information 174 and a column for click count 176. A last login date and time 178 is also shown.

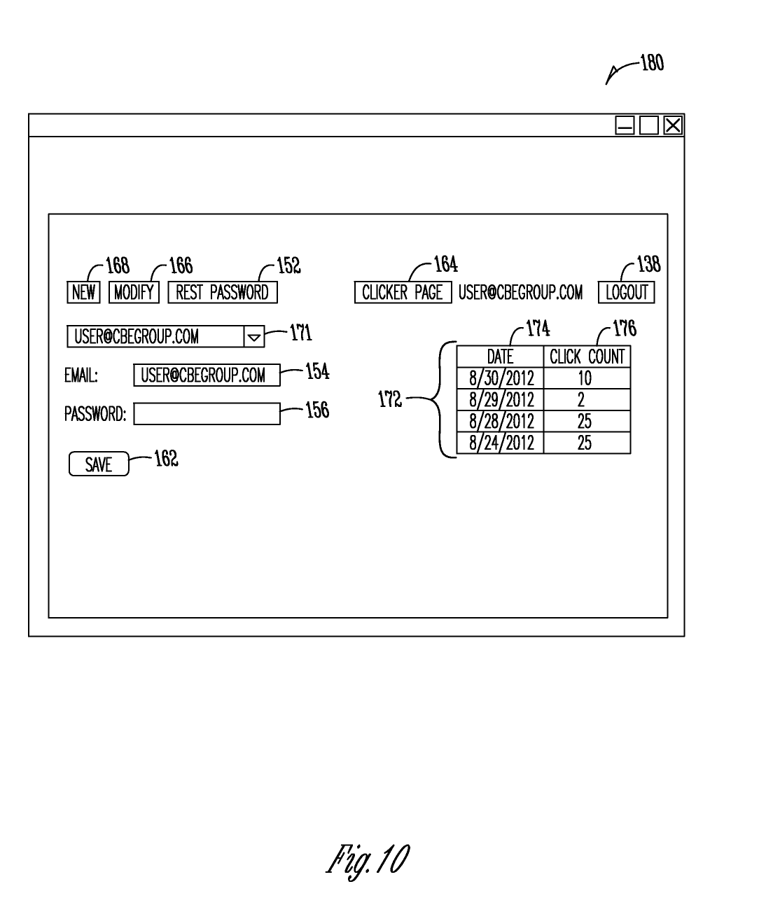

FIG. 10 illustrates a screen display 180 which shows user information which may be used for resetting a password associated with a user such as may be displayed after selecting button or tab 152.

Although various embodiments are shown or described herein, the present invention contemplates numerous variations, options, and alternatives as may be appropriate for a particular implementation or use within a particular environment. For example, the present invention contemplates variations in which clicks are performed, whether the user performing the clicks is the phone operator or not, the type of telecommunications systems which may be used in conjunction with the manual clicker application, variations in the user interface, and other variations, options, and alternatives.

What is claimed is:

1. A method for manual intervention in a dialing process, the method comprising:
(a) maintaining a list of records containing phone numbers in a database stored on a computer readable storage medium;
(b) receiving at a computer and from the user a click for each of the records within the list of records in the database stored on the computer readable storage medium;
(c) storing on a computer readable storage medium a record of the click, an identity of the user performing the click, and an association between the click and one of the records within the list of records;
(d) for each click electronically communicating the corresponding phone number of one of the records within the list to a telecommunications system for dialing the phone number.

2. The method of claim 1 further comprising dialing the phone number using the telecommunications system.

3. The method of claim 2 further comprising displaying an icon to the user and wherein the click for each of the records within the list of records is a click on the icon.

4. The method of claim 3 wherein the click is performed by positioning a mouse pointer on the click and depressing a button of a mouse.

5. The method of claim 4 wherein the phone numbers are phone numbers for unauthorized cell phones.

6. The method of claim 1 further comprising determining if phone numbers are unauthorized cell phone numbers, for phone numbers which are unauthorized cell phone numbers, placing the phone numbers in the list of records containing the phone numbers, and for phone numbers which are not unauthorized cell phone numbers sending the phone numbers directly to the telecommunications system.

7. The method of claim 1 further comprising providing a cloud-based service and providing a manual clicker application to the user through the cloud-based server wherein the cloud-based service provides for performing steps (a)-(d).

8. The method of claim 1 further comprising displaying to a user a number of clicks performed with the list.

9. The method of claim 8 further comprising displaying a number of clicks remaining to be performed with the list.

10. The method of claim 1 further comprising limiting the clicks to a maximum number of clicks.

11. A method for providing a cloud-based service to provide for manual intervention in a dialing process, the method comprising:
maintaining a list of records containing unauthorized phone numbers in a database stored on a computer readable storage medium;
providing access to a manual clicker application through a server configured to access the database;
providing a user interface to a user of the manual clicker application, the user interface configured to receive clicks from a user;
receiving clicks from the user targeted at an icon of the user interface;
storing within the database a record of each click from a user and associating each click from the user with one of the records and a corresponding unauthorized phone number;
electronically communicating to a telecommunications system each of the corresponding unauthorized phone numbers after storing the record of each click.

12. The method of claim 11 further comprising dialing each of the corresponding unauthorized phone numbers using the telecommunications system.

13. The method of claim 11 wherein the clicks are performed by a user using a mouse.

14. The method of claim 11 further comprising displaying to a user a number of clicks performed with the list of records.

15. The method of claim 14 further comprising displaying to a user a number of clicks remaining to be performed with the list of records.

16. The method of claim 11 further comprising notifying the user when there has been a click for every one of the records in the list of records.

17. The method of claim 11 further comprising receiving a selection of the list by the user through the user interface.

18. The method of claim 11 further comprising determining if phone numbers are unauthorized cell phone numbers, for phone numbers which are unauthorized cell phone numbers, placing the unauthorized cell phone numbers in the list of records and for phone numbers which are not unauthorized cell phone numbers sending the phone numbers directly to the telecommunications system.
